(19) United States
(12) Patent Application Publication
(10) Pub. No.: US 2026/0365023 A1
(43) Pub. Date: Nov. 19, 2026

(54) INFORMATION PRESENTATION APPARATUS

(71) Applicant: SUBARU CORPORATION, Tokyo (JP)

(72) Inventors: Ikuo GOTO, Tokyo (JP); Shuhei WADA, Tokyo (JP)

(21) Appl. No.: 19/657,563

(22) Filed: Apr. 24, 2026

(30) Foreign Application Priority Data
May 19, 2025 (JP) 2025-083012

(51) Int. Cl. B60K 35/29; B60K 35/28

(52) U.S. Cl. CPC B60K 35/29; B60K 35/28

(57) ABSTRACT

An information presentation apparatus includes one or more processors and one or more memories communicably coupled to the one or more processors. The one or more processors are configured to acquire information regarding an operation state of a vehicle which the driver drives in the surrounding traffic situation or behavior of the vehicle. The one or more processors are configured to perform, based on the information regarding the operation state or the behavior of the vehicle, a determination of frequency with which a driver has performed a recommended action corresponding to an event to pay attention to in accordance with information presentation. The one or more processors are configured to change, based on a result of the determination of the frequency with which the driver has performed the recommended action, an expression in the information presentation to vary an impression which the driver is to receive from the information presentation.

### CROSS-REFERENCE TO RELATED APPLICATIONS

The present application claims priority from Japanese Patent Application No. 2025-083012 filed on May 19, 2025, the entire contents of which are hereby incorporated by reference.

### BACKGROUND

The disclosure relates to an information presentation apparatus.

Occurrence of an event such as an accident may be prevented if a driver drives a vehicle, based on an estimation of a risk. For example, at a crossroad with poor visibility, if the driver decelerates the vehicle in advance, the driver may be able to deal with the situation when something suddenly comes out. There has been known a technique of alerting the driver or presenting information to the driver in a situation that may involve a risk.

As such a technique, for example, Japanese Unexamined Patent Application Publication (JP-A) No. 2022-141011 proposes a technique of appropriately performing guidance notification through a notification sound such as a signaling sound or a message, depending on a situation which a driver who drives a vehicle is in. For example, JP-A No. 2022-141011 proposes a technique of acquiring, when determining a characteristic of the notification sound to be outputted for the driver, an index representing a mental state of the driver, and determining the characteristic of the notification sound, based on the acquired index.

### SUMMARY

An aspect of the disclosure provides an information presentation apparatus configured to perform information presentation, to a driver who drives a vehicle, regarding an event to pay attention to in a surrounding traffic situation in which the vehicle is traveling, or regarding a recommended action corresponding to the event to pay attention to. The information presentation apparatus includes one or more processors and one or more memories communicably coupled to the one or more processors. The one or more processors is configured to: acquire information regarding an operation state of the vehicle which the driver drives in the surrounding traffic situation or behavior of the vehicle; perform, based on the information regarding the operation state of the vehicle or the behavior of the vehicle, a determination of frequency with which the driver has performed the recommended action corresponding to the event to pay attention to in accordance with the information presentation; and change, based on a result of the determination of the frequency with which the driver has performed the recommended action, an expression in the information presentation to vary an impression which the driver is to receive from the information presentation.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic diagram illustrating a configuration example of a vehicle including an information presentation apparatus according to one example embodiment of the disclosure.

FIG. 2 is a block diagram illustrating a configuration example of the information presentation apparatus according to one example embodiment.

FIG. 3 is an explanatory diagram for describing a basic example of a difference in expression based on a difference in influence factor related to an expression to be presented by the information presentation apparatus according to one example embodiment.

FIG. 4 is an explanatory diagram for describing an example of a method of determining the influence factor, to be performed by the information presentation apparatus according to one example embodiment.

FIG. 5 is a flowchart illustrating an example of a processing operation to be performed by the information presentation apparatus according to one example embodiment.

FIG. 6 is a flowchart illustrating an example of a process of setting an expression strength of information presentation to be performed by the information presentation apparatus according to one example embodiment.

FIG. 7 is a flowchart illustrating an example of a process of setting an expression in the information presentation, based on the influence factors related to an action request expression to be presented by the information presentation apparatus according to one example embodiment.

FIG. 8 is a flowchart illustrating an example of a process of setting the influence factors related to the action request expression and the expression in the information presentation to be used by the information presentation apparatus according to one example embodiment.

FIG. 9 is a diagram for describing an example of the information presentation to be performed by an information presentation apparatus according to one example embodiment of the disclosure.

FIG. 10 is an explanatory diagram illustrating an example of the information presentation to be performed by the information presentation apparatus according to one example embodiment.

FIG. 11 is a diagram for describing another example of the information presentation to be performed by the information presentation apparatus according to one example embodiment of the disclosure.

FIG. 12 is an explanatory diagram illustrating still another example of the information presentation to be performed by the information presentation apparatus according to one example embodiment.

### DETAILED DESCRIPTION

In performing information presentation to a driver who drives a vehicle, to achieve an expected effect such as deceleration of the vehicle in advance, it may be desirable to make the driver actively engage in safe driving. To achieve such active engagement of the driver, a self-determining feeling may be taken into consideration. Taking into consideration the self-determining feeling, information presentation that forces or instructs the driver to drive safely can decrease the self-determining feeling of the driver and can thus make it difficult to achieve the expected effect. However, if the driver is not experienced in driving or is not used to driving, information presentation that gives a forcing or instructing impression may make it easier for the driver to understand what kind of action he, she, or they is to take, and may thus help to achieve the expected effect more easily. As described above, the information presentation that forces or instructs the driver to take a particular action may be effective for some drivers. Which is effective of the two kinds of information presentation, i.e., the information presentation that gives less of the forcing or instructing impression and tends to increase the self-determining feeling and the information presentation that gives more of the forcing or instructing impression and tends to decrease the self-determining feeling, may depend on the type of the individual driver.

It is desirable to provide an information presentation apparatus that makes it possible to select appropriate information presentation, based on a tendency of an impression which an individual driver who drives a vehicle is to receive from information presentation.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### 1. First Example Embodiment

### 1-1. Outline

First, a description is given of an outline of an information presentation apparatus according to a first example embodiment of the disclosure.

When, for example, a person, an organization, or a function requests, for example, another person or another organization to perform some kind of action, an impression which the person or the organization receives from the request may influence whether the person who or the organization which has been requested to perform the action actively performs the action. For example, when the person who or the organization which has been requested to perform the action receives a strong forcing or instructing impression from the request, such an impression can decrease a self-determining feeling and thus make the person or the organization reluctant to actively perform the action. For example, when the person who or the organization which has been requested to perform the action receives a weak forcing or instructing impression from the request, such an impression may not decrease the self-determining feeling but can make it difficult for the person or the organization to understand the intention of the request and thus prevent the person or the organization from easily performing the action. For example, when the person who or the organization which has been requested to perform the action receives an appropriate forcing or instructing impression from the request, such an impression may give the self-determining feeling to the person or the organization and help to cause the person or the organization to perform the action.

Regarding a linguistic expression to be used when, for example, the person, the organization, or the function requests, for example, another person or another organization to perform some kind of action, a concept “directive expression” or an action request expression is known. For example, see Kim, “Consideration of Classification of Modern Japanese Directive Expression”, “Journal of Intercultural Communication: Ibunka”, Vol. 17, p. 183-204 (2016). In relation to the action request expression, there may be three factors: “who or what is to perform the action”, i.e., an “actor”; “who or what is to benefit from the action”, i.e., a “beneficiary”; and “who or what is to decide the action”, i.e., a “decider”. Hereinafter, these three factors may be referred to as “influence factors”. In relation to driving behavior related to a traveling vehicle, the action request expression in requesting someone or something to perform a recommended action corresponding to an event to pay attention to in a surrounding traffic situation may involve an actor that is to perform the recommended action, a beneficiary that is to benefit from performing of the recommended action, and a decider that is to decide that the recommended action is to be performed.

According to the first example embodiment, the information presentation apparatus is configured to perform a determination of frequency with which a driver, who drives a vehicle, has performed a recommended action corresponding to an event to pay attention to in accordance with information presentation. The information presentation apparatus may set a degree of a forcing or instructing impression given by the information presentation to allow the driver to receive an appropriate forcing or instructing impression regarding the recommended action included in the information presentation, and to thus increase the frequency with which the driver performs the recommended action.

According to the first example embodiment, the information presentation apparatus may estimate a degree of an influence which each of a passenger of the vehicle, a surrounding traffic participant of the vehicle, and a social rule has on driving behavior of the driver, based on first information regarding the passenger, second information regarding the surrounding traffic participant, and third information regarding an operation state of the vehicle or behavior of the vehicle. The passenger may be an occupant in the vehicle which the driver drives. The information presentation apparatus may set one or more of the driver, the vehicle, the passenger, the surrounding traffic participant, and the social rule to each of an actor, a beneficiary, and a decider, and change the expression in the information presentation by changing what is set to each of the actor, the beneficiary, and the decider. The information presentation apparatus may thus so determine the expression in the information presentation as to increase the frequency with which the driver performs the recommended action.

The driver, the vehicle, the passenger, the surrounding traffic participant, and the social rule may be a subject that can be any of the actor, the beneficiary, and the decider. The “driver” may refer to a person who operates driving of the vehicle. The “vehicle” may refer to the vehicle as a subject in a situation where the vehicle performs automatic driving. The “passenger” may refer to a person who is present in the vehicle other than the driver, and may be classified based on an attribute such a family or a friend. The “surrounding traffic participant” may refer to a person or a mobile body such as a pedestrian, a bicycle, or another vehicle present in a surrounding traffic situation of the vehicle, and may be classified based on an attribute such as a child, an elderly person, a police officer, or a police vehicle. The “social rule” may refer to a community or a third party as a subject that obeys a rule as a social demand.

### 1-2. Overall Configuration of Vehicle

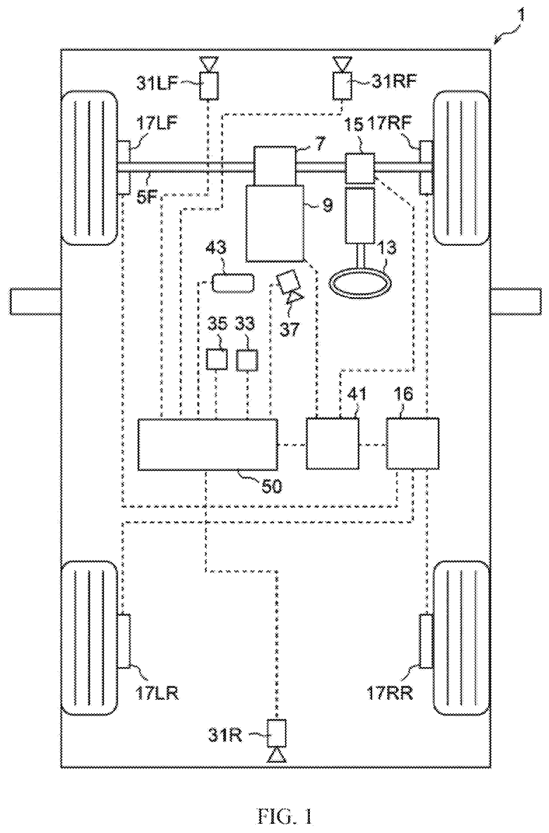

FIG. 1 is a schematic diagram illustrating a configuration example of a vehicle 1 including an information presentation apparatus 50.

The vehicle 1 may be configured as a two-wheel drive four-wheeled vehicle in which drive torque outputted from a driving source 9 is transmitted to a left front wheel and a right front wheel. In some embodiments, the driving source 9 may be an internal combustion engine such as a gasoline engine or a diesel engine. In some embodiments, the driving source 9 may be a driving motor. In some embodiments, the driving source 9 may include both the internal combustion engine and the driving motor.

In some embodiments, the vehicle 1 may be a four-wheel drive vehicle in which drive torque is transmitted to front wheels and rear wheels. In some embodiments, the vehicle 1 may be, for example, an electric vehicle that includes two driving motors, e.g., a front-wheel driving motor and a rear-wheel driving motor. In some embodiments, the vehicle 1 may be, for example, an electric vehicle that includes driving motors corresponding to respective wheels. In some embodiments, when the vehicle 1 is, for example, the electric vehicle or a hybrid electric vehicle, the vehicle 1 may include a secondary battery that stores electric power to be supplied to the driving motor, or may include a generator such as a motor that generates electric power to charge the secondary battery, or a fuel battery.

The vehicle 1 may include, as devices to be used in driving control of the vehicle 1, the driving source 9, an electric steering device 15, and brake devices 17LF, 17RF, 17LR, and 17RR. Hereinafter, the brake devices 17LF, 17RF, 17LR, and 17RR may be generally referred to as “brake devices 17” unless it is necessary to specifically distinguish them from one another. The driving source 9 may output drive torque to be transmitted to a front-wheel drive shaft 5F via an unillustrated transmission or a differential mechanism 7. Driving of the devices including, without limitation, the driving source 9 and the transmission may be controlled by a vehicle control device 41 that includes one or more electronic control units (ECUs).

The electric steering device 15 may include an unillustrated electric motor or an unillustrated gear mechanism, and may adjust steering angles of the left and right front wheels under a control by the vehicle control device 41. While a driving mode is set to a manual driving mode, the vehicle control device 41 may control the electric steering device 15, based on a steering wheel angle of a steering wheel operated by a driver who drives the vehicle 1. While a driving assistance operation or an automatic driving mode is activated, the vehicle control device 41 may so control the electric steering device 15 as to cause the vehicle 1 to travel maintaining a predetermined position.

The brake device 17 may apply braking force to each of the left front wheel, the right front wheel, the left rear wheel, and the right rear wheel. The brake device 17 may be configured as, for example, a hydraulic brake device. Predetermined braking force may be generated by a hydraulic control unit 16 adjusting a hydraulic pressure to be supplied to each of the brake devices 17, based on a drive command inputted from the vehicle control device 41. When the vehicle 1 is the electric vehicle or the hybrid electric vehicle, the brake devices 17 may be used together with regenerative braking of the driving motor.

The vehicle control device 41 may include the one or more electronic control units configured to control driving of each of the driving source 9, the electric steering device 15, and the hydraulic control unit 16. In some embodiments, the vehicle control device 41 may be configured to control driving of the transmission that varies an output from the driving source 9 and transmits the varied output to the wheels.

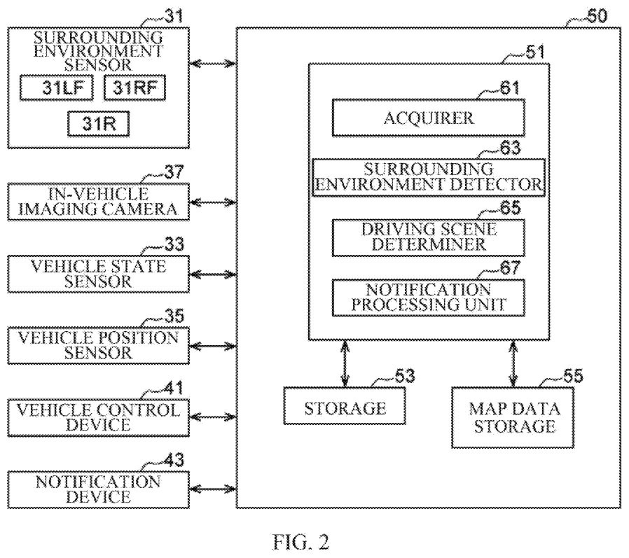

The vehicle 1 may further include a surrounding environment sensor 31 (see FIG. 2 to be described later), a vehicle state sensor 33, a vehicle position sensor 35, an in-vehicle imaging camera 37, and a notification device 43. The surrounding environment sensor 31 may include a front imaging cameras 31LF and 31RF and a rear imaging camera 31R.

The surrounding environment sensor 31 may be configured to acquire information regarding a surrounding environment of the vehicle 1, and may include, for example, the front imaging cameras 31LF and 31RF and the rear imaging camera 31R, as described above. Each of the front imaging cameras 31LF and 31RF may capture an image of a region in front of the vehicle 1 and generate image data. The rear imaging camera 31R may capture an image of a region behind the vehicle 1 and generate image data. Each of the front imaging cameras 31LF and 31RF and the rear imaging camera 31R may be an imager including an imaging device such as a charged coupled device (CCD) or a complementary metal oxide semiconductor (CMOS). Each of the front imaging cameras 31LF and 31RF and the rear imaging camera 31R may send the generated image data to the information presentation apparatus 50. In the vehicle 1 illustrated in FIG. 1, the front imaging cameras 31LF and 31RF may each be configured as a stereo camera including a pair of a left camera and a right camera. However, in some embodiments, the front imaging cameras 31LF and 31R may each be a monocular camera. In some embodiments, the front imaging cameras 31LF and 31R may each include both the stereo camera and the monocular camera.

In some embodiments, the surrounding environment sensor 31 may include, for example, cameras that are provided on respective side mirrors and capture images of respective regions on a left side and a right side of the vehicle 1, in addition to the front imaging cameras 31LF and 31RF and the rear imaging camera 31R. In some embodiments, the surrounding environment sensor 31 may further include any one or more of sensors including, without limitation, a radar sensor and an ultrasonic sensor. Non-limiting examples of the radar sensor may include a light detection and ranging (LiDAR) and a millimeter wave radar.

The vehicle state sensor 33 may include one or more sensors that each detect an operation state of the vehicle 1 and behavior of the vehicle 1. The vehicle state sensor 33 may include, for example, one or more of sensors including, without limitation, a steering angle sensor, an accelerator position sensor, a brake stroke sensor, a brake pressure sensor, and an engine speed sensor. The vehicle state sensor 33 may further include, for example, one or more of sensors including, without limitation, a vehicle speed sensor, an acceleration sensor, and an angular velocity sensor. The vehicle state sensor 33 may further include a switch that detects on and off states of a turn signal lamp. The vehicle state sensor 33 may output a sensor signal indicating detected information to the information presentation apparatus 50.

The vehicle position sensor 35 may receive a satellite signal from a positioning satellite of a global navigation satellite system (GNSS) such as a global positioning system (GPS). The vehicle position sensor 35 may send position information of the vehicle 1 included in the received satellite signal to the information presentation apparatus 50. In some embodiments, the vehicle position sensor 35 may be an antenna that receives a satellite signal from another satellite system that identifies a position of the vehicle 1, instead of the GPS sensor.

The in-vehicle imaging camera 37 may capture an image of the driver who drives the vehicle 1 and generate image data. The in-vehicle imaging camera 37 may be an imager including an imaging device such as a CCD or a CMOS. The in-vehicle imaging camera 37 may send the generated image data to the information presentation apparatus 50.

The notification device 43 may be driven by the information presentation apparatus 50, and may notify the driver of various kinds of information by a method such as an image display or an audio output. The notification device 43 may include, for example, a display device and a speaker. The display device may be provided in an instrument panel. The speaker may be provided in the vehicle 1. In some embodiments, the display device may be a display device of a navigation system. In some embodiments, the notification device 43 may be a head-up display (HUD) that displays an image on a front windshield.

### 1-3. Information Presentation Apparatus

Next, a detailed description will be given of the information presentation apparatus 50 according to the first example embodiment.

### 1-3-1. Configuration Example

The information presentation apparatus 50 may present information to the driver by one or more processors executing a computer program. Non-limiting examples of each of the one or more processors may include a central processing unit (CPU). The computer program may be adapted to cause the one or more processors to execute a later-described operation to be performed by the information presentation apparatus 50. In some embodiments, the computer program to be executed by the one or more processors may be recorded in a recording medium as a storage (a memory) 53 included in the information presentation apparatus 50. In some embodiments, the computer program to be executed by the one or more processors may be recorded in a recording medium incorporated in the information presentation apparatus 50 or any external recording medium attachable to the information presentation apparatus 50.

Non-limiting examples of the recording medium in which the computer program is recorded may include: a magnetic medium such as a hard disk, a floppy disk, or a magnetic tape; an optical recording medium such as a compact disc read-only memory (CD-ROM), a digital versatile disc (DVD), or Blu-ray (registered trademark); a magneto-optical medium such as a floptical disk; a memory such as a RAM or a ROM; a flash memory such as a universal serial bus (USB) memory or a solid state drive (SSD); and any other medium configured to contain a program.

FIG. 2 is a block diagram illustrating a configuration example of the information presentation apparatus 50 according to the first example embodiment.

The surrounding environment sensor 31, the in-vehicle imaging camera 37, the vehicle state sensor 33, and the vehicle position sensor 35 may be coupled to the information presentation apparatus 50 via a dedicated line or a communication network such as a controller area network (CAN) or a local interconnect network (LIN). Further, the vehicle control device 41 and the notification device 43 may be coupled to the information presentation apparatus 50. The information presentation apparatus 50 is not limited to an electronic control unit mounted in the vehicle 1. In some embodiments, the information presentation apparatus 50 may be a terminal apparatus such as a smartphone or a wearable apparatus.

The information presentation apparatus 50 may include a processing circuit 51, a storage 53, and a map data storage 55. The processing circuit 51 may include one or more processors and various peripheral components. Non-limiting examples of each of the one or more processors may include a CPU. In some embodiments, all or a part of the processing circuit 51 may include updatable software such as firmware. In some embodiments, all or a part of the processing circuit 51 may include, for example, a program module to be executed in accordance with a command from a device such as the CPU. In one embodiment, the processing circuit 51 including the one or more processors may serve as “one or more processors”.

The storage 53 may include one or more storage devices communicably coupled to the processing circuit 51. Non-limiting examples of each of the storage devices may include a RAM and a ROM. Note that the storage 53 is not particularly limited in, for example, kind or number. The storage 53 may hold data including, without limitation, a computer program to be executed by the processing circuit 51, various parameters to be used in calculation processes, detection data, and information such as a calculation result. A part of the storage 53 may serve as a work area of the processing circuit 51. In one embodiment, the storage 53 including the one or more storage devices may serve as “one or more memories”.

The map data storage 55 may include a storage device or a storage medium that is communicably coupled to the processing circuit 51, and may hold the map data. Non-limiting examples of the storage device may include a RAM and a ROM. Non-limiting examples of the storage medium may include a hard disk drive (HDD), a CD, a DVD, an SSD, a USB flash, and a storage device. The map data may include information that allows for identification of the position of the vehicle 1, based on the position information detected by the vehicle position sensor 35. For example, the map data may be associated with information regarding a latitude and a longitude, and the processing circuit 51 may identify the position of the vehicle 1 on the map data, based on the information regarding the latitude and the longitude detected by the vehicle position sensor 35. In some embodiments, the map data may be, for example, three-dimensional high-precision map data including information regarding a speed limit, a curve, a road inclination, a road surface paint, a traffic sign, a traveling lane, a road structural object such as a guardrail.

The processing circuit 51 may include an acquirer 61, a surrounding environment detector 63, a driving scene determiner 65, and a notification processing unit 67. Each of the acquirer 61, the surrounding environment detector 63, the driving scene determiner 65, and the notification processing unit 67 may be implemented by execution of the computer program by the one or more processors such as the one or more CPUs. In some embodiments, all or a part of the acquirer 61, the surrounding environment detector 63, the driving scene determiner 65, and the notification processing unit 67 may include analog circuitry.

### <Acquirer>

The acquirer 61 may acquire, at a predetermined sampling period, a signal or data outputted from each of the surrounding environment sensor 31, the in-vehicle imaging camera 37, the vehicle state sensor 33, and the vehicle position sensor 35. In the first example embodiment, the acquirer 61 may acquire the image data sent from each of the front imaging cameras 31LF and 31RF, the rear imaging camera 31R, and the in-vehicle imaging camera 37. When the surrounding environment sensor 31 includes a sensor such as the LiDAR or the radar sensor other than the front imaging cameras 31LF and 31RF and the rear imaging camera 31R, the acquirer 61 may acquire measurement information such as point cloud data of measurement points from each of the sensors. The acquirer 61 may also acquire a signal indicating each of the operation state and the behavior of the vehicle 1 outputted from the vehicle state sensor 33, and a signal indicating the position information of the vehicle 1 outputted from the vehicle position sensor 35.

### <Surrounding Environment Detector>

The surrounding environment detector 63 may detect the surrounding environment of the vehicle 1, based on the information acquired from the surrounding environment sensor 31. For example, the surrounding environment detector 63 may extract feature points from the image data or the point cloud data, and may recognize an object by finding data corresponding to a pattern of the extracted feature points from reference data prepared in advance. The surrounding environment detector 63 may recognize a mobile body such as a human, a bicycle, a motorcycle, or a four-wheel vehicle; an artificial or natural stationary object; and various other objects including, without limitation, a road surface paint painted on a road, such as a border line or a crosswalk. The surrounding environment detector 63 may calculate a position of the recognized object, a speed of the recognized object, and a distance to the recognized object.

In some embodiments, the surrounding environment sensor 31 may be configured to recognize, for example, the above-described mobile body, the stationary object, and the various other objects. In this case, the information presentation apparatus 50 may acquire information including a result of recognizing such objects, from the surrounding environment sensor 31.

### <Driving Scene Determiner>

The driving scene determiner 65 may determine whether a driving scene of the vehicle 1 is a predetermined driving scene set in advance, based on a surrounding situation of the vehicle 1 recognized by the surrounding environment detector 63. The predetermined driving scene may include an event to pay attention to in a surrounding traffic situation in which the vehicle 1 with the driver is traveling. The predetermined driving scene may be set as desired in advance. In some embodiments, the predetermined driving scene may be, for example, a driving scene in which the vehicle 1 can come into contact with another object. Non-limiting examples of such a driving scene may include a driving scene in which the vehicle 1 travels through a crosswalk with no traffic light, a driving scene in which the vehicle 1 travels through a crossroad with poor visibility, a driving scene in which the vehicle 1 travels through a meeting point at which a side road joins a main road, and a driving scene in which another vehicle on an adjacent lane suddenly cuts in on a lane where the vehicle 1 is traveling. In some embodiments, the predetermined driving scene may be, for example, a driving scene in which the vehicle 1 can spin. Non-limiting examples of such a driving scene may include a driving scene in which the vehicle 1 travels down a steep downhill slope, a driving scene in which the vehicle 1 travels through a curve having a small radius of curvature, and a driving scene in which the vehicle 1 travels on a road with a frozen road surface. In some embodiments, any driving scene that can put the vehicle 1 at risk may be set to the predetermined driving scene.

In some embodiments, the driving scene determiner 65 may determine whether the vehicle 1 travels in the predetermined driving scene, based on the position of the vehicle 1 on the map data, the information regarding the map data, and a traveling direction of the vehicle 1, in addition to the surrounding situation of the vehicle 1 recognized by the surrounding environment detector 63. The position of the vehicle 1 on the map data may be identified based on the position information of the vehicle 1 sent from the vehicle position sensor 35.

### <Notification Processing Unit>

The notification processing unit 67 may perform a notification process of performing information presentation, to the driver, regarding the event to pay attention to in the surrounding traffic situation in which the vehicle 1 is traveling, or regarding a recommended action corresponding to the event to pay attention to. The notification processing unit 67 may perform the information presentation to the driver by, for example, outputting a sound or a voice or displaying an image or a text. The notification processing unit 67 may acquire the information regarding the operation state or the behavior of the vehicle 1 which the driver drives in the surrounding traffic situation in which the vehicle 1 is traveling, and may perform, based on the acquired information regarding the operation state or the behavior of the vehicle 1, a determination of frequency with which the driver has performed the recommended action corresponding to the event to pay attention to in accordance with the information presentation.

The notification processing unit 67 may change, based on a result of the determination of the frequency with which the driver has performed the recommended action, an expression in the information presentation to vary an impression which the driver is to receive from the information presentation. According to the first example embodiment, the notification processing unit 67 may change a degree of a forcing or instructing impression of the expression in the information presentation, based on the determined frequency, and may lead the driver to perform the recommended action corresponding to the event to pay attention to in accordance with the information presentation. Hereinafter, the degree of the forcing or instructing impression of the expression in the information presentation may also be referred to as “expression strength”. In addition, the notification processing unit 67 may change the expression in the information presentation by changing the influence factors related to the expression in the information presentation.

### <Setting of Expression Strength>

For example, the notification processing unit 67 may set, to frequency Frq, a ratio of the number of times the driver has performed the recommended action to the number of times the predetermined driving scene in which safe driving is expected has occurred. The notification processing unit 67 may estimate the impression which the driver has received from the information presentation, as described in Table 1. In some embodiments, for example, a case in which the frequency is higher than 50% may be determined as “high frequency”, and a case in which the frequency is 50% or lower may be determined as “low frequency”. However, in some embodiments, the high frequency and the low frequency may be determined based on a different condition.

TABLE 1

| Driver's state | Impression |
|---|---|
| State (A) in which behavior corresponding to | The forcing or instructing impression is very |
| the recommended action, such as deceleration | weak. Although the self-determining |
| in advance, has been performed with low | feeling of the driver is not suppressed, it is |
| frequency from the beginning of | difficult for the driver to understand the |
| experiencing the information presentation. | intention of the information presentation. It |
| | is thus difficult to cause the driver to perform |
| | the recommended action. |
| State (B) in which the behavior | The forcing or instructing impression is |
| corresponding to the recommended action, | appropriate and is providing the driver with |
| such as the deceleration in advance, is | an appropriate degree of self-determining |
| performed with high frequency if the | feeling. The driver can easily perform the |
| information presentation continues for a long | recommended action. |
| time. | |
| State (C) in which the behavior | The forcing or instructing impression is |
| corresponding to the recommended action, | strong. The self-determining feeling of the |
| such as the deceleration in advance, is | driver is suppressed. The driver grows |
| performed with high frequency at the | reluctant to actively perform the |
| beginning of experiencing the information | recommended action. |
| presentation, but the frequency decreases as | |
| the experience increases. | |

When the driver's state is estimated to be the state (A) or (C) described above, the driver's state changing to the state (B) may mean that the driver is in a state of performing the recommended action with an appropriate degree of self-determining feeling, and an effect of the information presentation further increases. Therefore, the notification processing unit 67 may change the expression strength of the information presentation so that the driver's state becomes the state (B). In the first example embodiment, the notification processing unit 67 may determine the driver's state in relation to the information presentation for each predetermined driving scene, and may change the expression strength of the information presentation so that the driver's state becomes the state (B).

The expression strength of the information presentation may be set among, for example, four levels: “order”, “request”, “advice”, and “invitation”. In this case, the “order” may be an expression having the highest expression strength, and the “invitation” may be an expression having the lowest expression strength. Note that the above-described setting of the expression strength of the information presentation is merely an example, and the expression strength of the information presentation may be set by any appropriate method.

### <Expression Setting Based on Influence Factors Related to Expression>

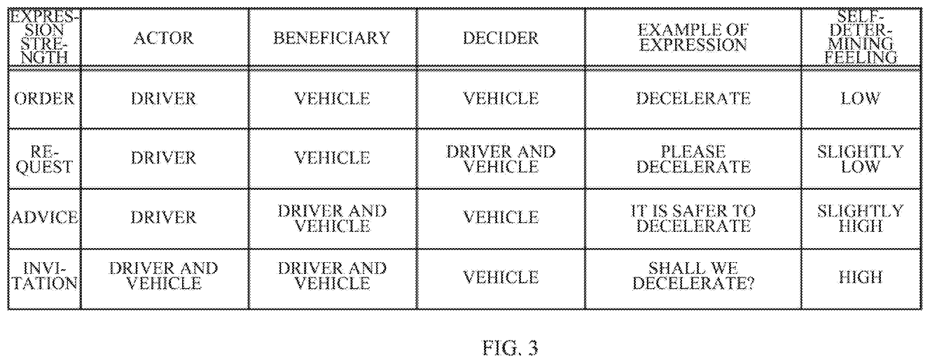

FIG. 3 describes a basic example of different expressions based on differences in the actor, the beneficiary, and the decider that are the influence factors related to the expression. FIG. 3 is an example of the expression strengths for requesting deceleration in a driving scene in which the deceleration of the vehicle 1 is suitable, and an impression which the driver is to receive from each of the expression strengths. The impression which the driver is to receive may be represented by a high-low degree of the self-determining feeling.

For example, when the expression strength is the “order”, the actor may be the “driver”, both the beneficiary and the decider may be the “vehicle”, and an example of the expression may be “Decelerate”. In this case, the driver may decelerate the vehicle 1 in accordance with the order. This may make the self-determining feeling of the driver “low”.

When the expression strength is the “request”, the actor may be the “driver”, the beneficiary may be the “vehicle”, the decider may be the “driver and vehicle”, and an example of the expression may be “Please decelerate”. In this case, the driver may accept the request and decelerate the vehicle 1. This may make the self-determining feeling of the driver “slightly low”.

When the expression strength is the “advice”, the actor may be the “driver”, the beneficiary may be the “driver and vehicle”, the decider may be the “driver”, and an example of the expression may be “It is safer to decelerate”. In this case, the driver may decide to follow the advice and decelerate the vehicle 1. This may make the self-determining feeling of the driver “slightly high”.

When the expression strength is the “invitation”, the actor may be the “driver and vehicle”, the beneficiary may be the “driver and vehicle”, the decider may be the “driver”, and an example of the expression may be “Shall we decelerate?”. In this case, the driver may decide to accept the invitation and decelerate the vehicle 1. This may make the self-determining feeling of the driver “high”.

Using the example described in FIG. 3 as a basic example, the notification processing unit 67 may change the setting of the influence factors to those having a higher degree of influence on the driving behavior of the driver, and may thus determine the expression in the information presentation.

### <Influence Factor I>

For example, when a family member of the driver is present in the vehicle 1 as the passenger, the driver may drive more safely than when the driver is alone in the vehicle 1. For example, the driver may carefully and slowly travel through the intersection with poor visibility. In such a case, the notification processing unit 67 may set a “family member” to the “beneficiary”, and may change the expression in the information presentation to an expression that matches the way the family member talks. For example, when the expression strength is the “request”, the expression may be “Can you decelerate?”, resembling the way the family member talks. For example, when the expression strength is the “advice”, the expression may be “If you can slow down, I may feel safer”, and the notification may be performed through a voice.

### <Influence Factor II>

For example, when a police vehicle is present as the surrounding traffic participant, the driver may drive more safely than when there is no police vehicle. For example, the driver may carefully and slowly travel through the intersection with poor visibility. In such a case, the notification processing unit 67 may set a “police” to the “decider”, and may change the expression in the information presentation to an expression related to the police. For example, when the expression strength is the “request”, the notification may be performed through a voice telling “please decelerate” and a police officer icon may be displayed. When the expression strength is the “advice”, the notification may be performed through a voice telling “you may be arrested if you don't decelerate” and the police officer icon may be displayed.

### <Influence Factor III>

Even if no passenger or no surrounding traffic participant is present, for example, when the driver has a tendency of driving safely, the notification processing unit 67 may set “community or third party” to the “beneficiary”, and change the expression in the information presentation to an expression that reminds the driver of the social rule and asks the driver to obey the rule. For example, when the expression strength is the “request”, the notification may be performed through the voice telling “please decelerate” and an illustration of an injured child may be displayed. When the expression strength is the “advice”, the notification may be performed through a voice telling “if you decelerate, you can avoid hurting people” and the illustration of the injured child may be displayed.

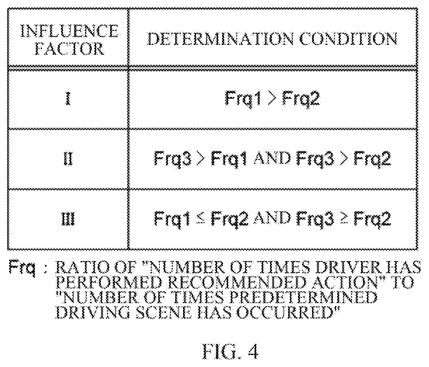

FIG. 4 illustrates an example of a method of determining whether the current situation corresponds to any of the situations described above in relation to the influence factors I to III as examples. “Frq1” may indicate first frequency that is the frequency in a driving scene in which a particular passenger is present in the vehicle 1. “Frq2” may indicate second frequency that is the frequency in a driving scene in which the driver is in the vehicle 1 alone to drive the vehicle 1. “Frq3” may indicate third frequency that is the frequency in a driving scene in which the police vehicle is present near the vehicle 1.

When the first frequency “Frq1” is higher than the second frequency “Frq2”, the notification processing unit 67 may determine that the influence factor I, i.e., the passenger, has the highest degree of influence on the driver's driving behavior. When the third frequency “Frq3” is higher than the first frequency “Frq1” and is also higher than the second frequency “Frq2”, the notification processing unit 67 may determine that the influence factor II, i.e., the surrounding traffic participant, has the highest degree of influence on the driver's driving behavior. When the first frequency “Frq1” is lower than or equal to the second frequency “Frq2”, and the third frequency “Frq3” is lower than or equal to the second frequency “Frq2”, the notification processing unit 67 may determine that the influence factor III, i.e., the social rule, has the highest degree of influence on the driver's driving behavior.

The notification processing unit 67 may determine which of the above-described influence factors I to III is the factor having a high degree of influence on the driver's driving behavior. The notification processing unit 67 may thus set the “beneficiary” and the “decider”, and determine the various expression methods based on the expression strength.

### 1-3-2. Operation Example

Next, a detailed description will be given of an operation example in a process to be performed by the information presentation apparatus 50 according to the first example embodiment.

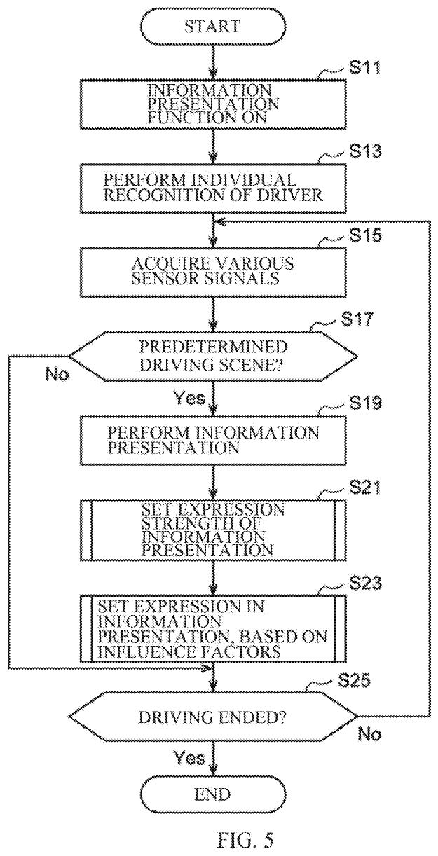

FIG. 5 is a flowchart illustrating a main routine of a processing operation to be performed by the processing circuit 51 of the information presentation apparatus 50 according to the first example embodiment. For example, the processing operation in the flowchart of FIG. 5 may be repeatedly performed when the information presentation operation of the information presentation apparatus 50 is on.

When the information presentation operation is turned on (step S11), the processing circuit 51 of the information presentation apparatus 50 may perform an individual recognition process regarding the driver (step S13). For example, the processing circuit 51 may extract a feature of a face extracted from the image data outputted from the in-vehicle imaging camera 37, and may refer to personal data stored in advance to perform the individual recognition of the driver. The driver may thus be identified.

Thereafter, the acquirer 61 may acquire the sensor signal outputted from each of the various sensors (step S15). For example, the acquirer 61 may acquire the sensor signal outputted from each of the front imaging cameras 31LF and 31RF, the vehicle state sensor 33, and the vehicle position sensor 35.

Thereafter, the driving scene determiner 65 may determine whether the driving scene of the vehicle 1 is the predetermined driving scene set in advance (step S17). For example, the surrounding environment detector 63 may detect the surrounding environment of the vehicle 1, based on the information acquired from the front imaging cameras 31LF and 31RF. The driving scene determiner 65 may determine, based on the surrounding situation of the vehicle 1 recognized by the surrounding environment detector 63, whether the driving scene of the vehicle 1 corresponds to any of the predetermined driving scenes set in advance that each include the event to pay attention to in the surrounding traffic situation in which the vehicle 1 with the driver is traveling.

When the driving scene determiner 65 does not determine that the driving scene of the vehicle 1 is the predetermined driving scene set in advance (step S17: No), the processing circuit 51 may cause the process to proceed to step S25. In contrast, when the driving scene determiner 65 determines that the driving scene of the vehicle 1 is the predetermined driving scene set in advance (step S17: Yes), the notification processing unit 67 may perform the information presentation (step S19). Here, the notification processing unit 67 may perform the information presentation regarding the recommended action to be performed by the driver in the predetermined driving scene, by the expression method based on the expression strength set for each driving scene at that time and the influence factors.

Thereafter, the notification processing unit 67 may perform a process of setting the expression strength of the information presentation (step S21).

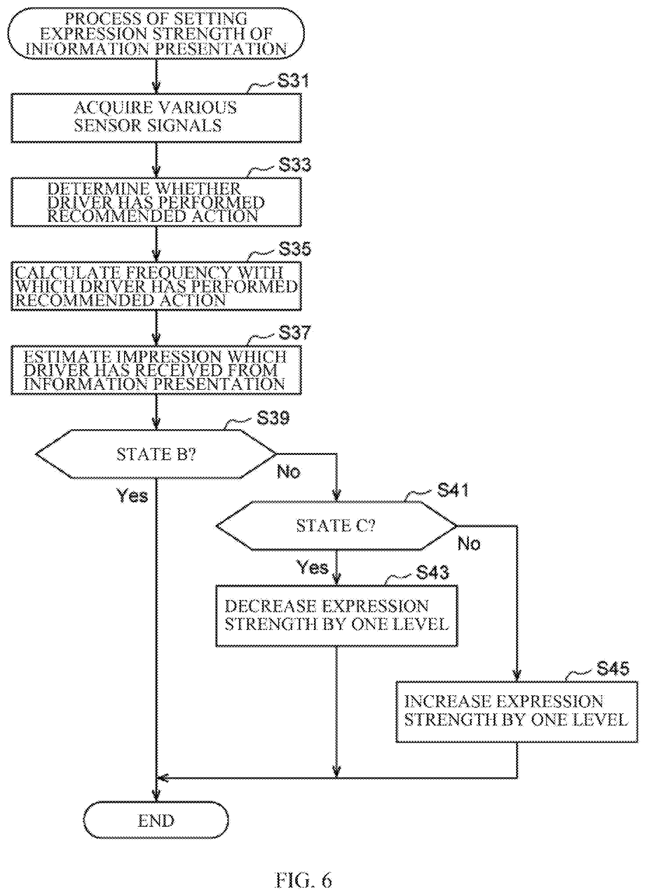

FIG. 6 illustrates a flowchart of the process of setting the expression strength of the information presentation.

After the information presentation in step S19, the acquirer 61 may acquire the sensor signal outputted from each of the various sensors, as in step S15 (step S31). Thereafter, the notification processing unit 67 may determine whether the driver has performed the recommended action in the information presentation (step S33). For example, the notification processing unit 67 may determine whether the driver has performed the recommended action in the information presentation, based on the information, i.e., the third information, regarding the operation state and the behavior detected by the sensor signal outputted from the vehicle state sensor 33, and the information regarding the surrounding environment recognized based on the image data outputted from the surrounding environment sensor 31.

Thereafter, the notification processing unit 67 may calculate the frequency with which the driver has performed the recommended action (step S35). For example, the notification processing unit 67 may read data regarding whether the driver has performed the recommended action when the driver has traveled through the same driving scene in the past, from accumulated data in the past recorded in the storage 53. The notification processing unit 67 may add the current data to the read data, and may determine, by calculation, the frequency Frq that is the ratio of the number of times the driver has performed the recommended action to the number of times the predetermined driving scene has occurred.

Thereafter, the notification processing unit 67 may estimate, based on the calculated frequency Frq, the impression which the driver has received from the information presentation (step S37). For example, as indicated in Table 1 above, the notification processing unit 67 may determine the driver's state, based on a tendency of the frequency in the predetermined driving scene, and estimate the impression which the driver has received from the information presentation.

Thereafter, the notification processing unit 67 may determine whether the driver's state is the state (B) (step S39). When the driver's state is determined to be the state (B) (step S39: Yes), it may be estimated that the forcing or instructing impression of the current expression in the information presentation is resulting in an appropriate self-determining feeling of the driver. Therefore, the notification processing unit 67 may end the process without changing the setting of the expression strength.

In contrast, when the driver's state is not determined to be the state (B) (step S39: No), the notification processing unit 67 may determine whether the driver's state is the state (C) (step S41). When the driver's state is determined to be the state (C) (step S41: Yes), it may be estimated that the forcing or instructing impression of the current expression in the information presentation is strong for the driver, and the self-determining feeling of the driver is suppressed. Therefore, the notification processing unit 67 may decrease the set expression strength by one level (step S43). For example, when the expression strength is settable among the four levels, i.e., the “order”, the “request”, the “advice”, and the “invitation”, and the expression strength is currently set to the “order”, the notification processing unit 67 may set the expression strength to the “request”. When the expression strength is currently set to the “request”, the notification processing unit 67 may set the expression strength to the “advice”. When the expression strength is currently set to the “advice”, the notification processing unit 67 may set the expression strength to the “invitation”. When the expression strength is currently set to the “invitation”, which is the lowest expression strength, the notification processing unit 67 may maintain the current setting.

In contrast, when the driver's state is not determined to be the state (C) (step S41: No), it may be estimated that the driver's state is the state (A), and the forcing or instructing impression of the current expression in the information presentation is weak for the driver. It may thus be estimated that although the self-determining feeling of the driver is not suppressed, it is difficult for the driver to understand the intention of the information presentation. Therefore, the notification processing unit 67 may increase the set expression strength by one level (step S45). For example, when the expression strength is settable among the four levels, i.e., the “order”, the “request”, the “advice”, and the “invitation”, and the expression strength is currently set to the “invitation”, the notification processing unit 67 may set the expression strength to the “advice”. When the expression strength is currently set to the “advice”, the notification processing unit 67 may set the expression strength to the “request”. When the expression strength is currently set to the “request”, the notification processing unit 67 may set the expression strength to the “order”. When the expression strength is currently set to the “order”, which is the highest expression strength, the notification processing unit 67 may maintain the current setting.

Referring again to FIG. 5, after performing the process of setting the expression strength of the information presentation, the notification processing unit 67 may perform a process of setting the expression in the information presentation, based on the influence factors related to the action request expression (step S23).

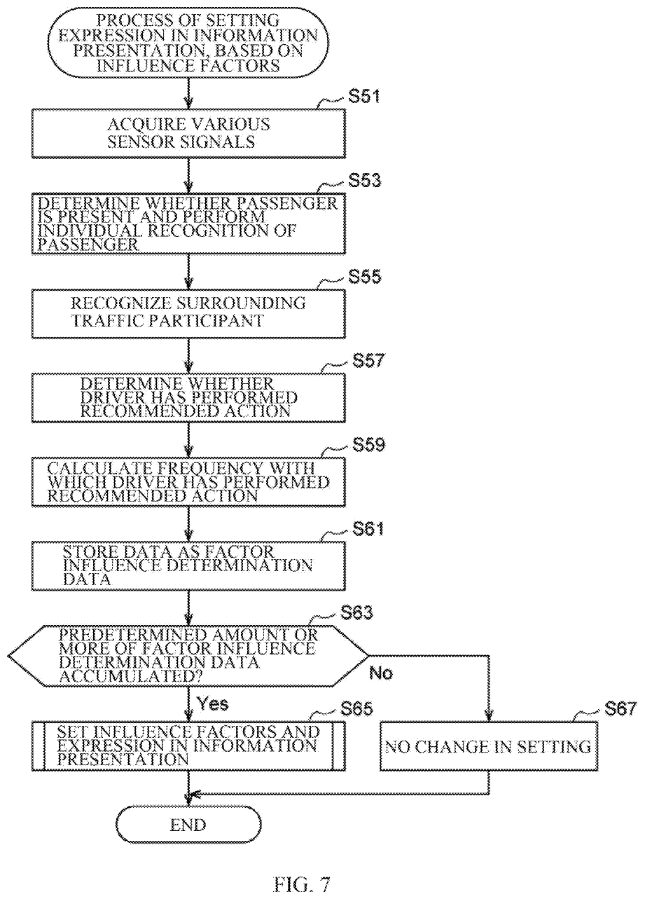

FIG. 7 illustrates a flowchart of the process of setting the expression in the information presentation, based on the influence factors related to the action request expression.

After the information presentation in step S19, the acquirer 61 may acquire the sensor signal outputted from each of the various sensors, as in step S15 (step S51). Thereafter, the notification processing unit 67 may perform a determination as to whether the passenger is present in the vehicle 1, perform an individual recognition of the passenger, and acquire the first information regarding the passenger (step S53). For example, the notification processing unit 67 may determine whether the passenger is present, based on the image data outputted from the in-vehicle imaging camera 37. When the passenger is present, the notification processing unit 67 may perform the individual recognition process of the passenger. For example, the notification processing unit 67 may extract a feature of a face extracted from the image data, and refer to personal data stored in advance to perform the individual recognition of the passenger. This may identify the attribute of the passenger. The attribute may indicate whether the passenger is a family member or an acquaintance such as a friend.

Thereafter, the notification processing unit 67 may recognize the surrounding traffic participant, and acquire the second information regarding the surrounding traffic participant (step S55). For example, the notification processing unit 67 may extract a feature from the image data outputted from the surrounding environment sensor 31, and determine whether the surrounding traffic participant is present by a process such as a pattern matching process. When the surrounding traffic participant is present, the notification processing unit 67 may determine whether a surrounding traffic participant having a particular attribute such as the police vehicle is present in the surrounding traffic participant that has been determined to be present.

Thereafter, the notification processing unit 67 may determine whether the driver has performed the recommended action in the information presentation in step S19 while the vehicle 1 travels through the predetermined driving scene (step S57). For example, the notification processing unit 67 may determine whether the driver has performed the driving behavior corresponding to the recommended action, based on the information, i.e., the third information, regarding the operation state and the behavior detected by the sensor signal outputted from the vehicle state sensor 33.

Thereafter, the notification processing unit 67 may calculate the frequency with which the driver has performed the recommended action (step S59). Here, the notification processing unit 67 may calculate, based on the first information regarding the passenger and the second information regarding the surrounding traffic participant, one or more of the first frequency Frq1 with which the driver has performed the recommended action in the driving scene in which the particular passenger is present in the vehicle 1 together, the second frequency Frq2 with which the driver has performed the recommended action in the driving scene in which the driver is in the vehicle 1 alone to drive, and the third frequency Frq3 with which the driver has performed the recommended action in the driving scene in which the police vehicle is present near the vehicle 1.

Thereafter, the notification processing unit 67 may store, as factor influence determination data, in relation to the current driving scene, a result of the determination as to whether the driver has performed the recommended action, based on the first information regarding the recognized passenger, the second information regarding the surrounding traffic participant, and the third information regarding the operation state of the vehicle 1 and the behavior of the vehicle 1, and a result of the calculation of the frequency with which the driver has performed the recommended action (step S61).

Thereafter, the notification processing unit 67 may determine whether a predetermined amount or more of the stored factor influence determination data is accumulated (step S63). For example, the notification processing unit 67 may determine whether the number of pieces of the factor influence determination data stored in relation to a driving scene same as the current driving scene is more than or equal to a threshold set in advance. In some embodiments, the threshold may be set to any value that is appropriate for evaluating the influence of the influence factor related to the action request expression. In some embodiments, alternatively, the notification processing unit 67 may determine whether each of the first frequency Frq1 with which the driver has performed the recommended action in the driving scene in which the particular passenger is present in the vehicle 1 together, the second frequency Frq2 with which the driver has performed the recommended action in the driving scene in which the driver is in the vehicle 1 alone to drive, and the third frequency Frq3 with which the driver has performed the recommended action in the driving scene in which the police vehicle is present near the vehicle 1 has been calculated.

When the predetermined amount or more of the stored factor influence determination data is not determined as being accumulated (step S63: No), the notification processing unit 67 may maintain the current setting of the expression in the information presentation without changing the setting (step S67), and may end the process. In contrast, when the predetermined amount or more of the stored factor influence determination data is determined as being accumulated (step S63: Yes), the notification processing unit 67 may perform the process of setting the influence factors related to the action request expression and the expression in the information presentation, based on the accumulated pieces of factor influence determination data (step S65).

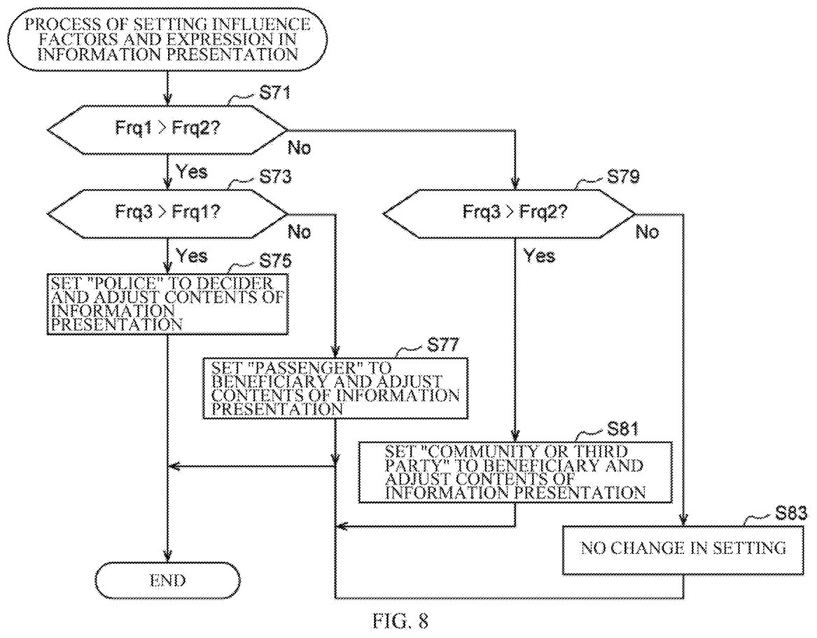

FIG. 8 illustrates a flowchart of an example of the process of setting the influence factors related to the action request expression and the expression in the information presentation.

The notification processing unit 67 may determine, based on the accumulated pieces of factor influence determination data, whether the first frequency Frq1 with which the driver has performed the recommended action in the driving scene in which the particular passenger is present in the vehicle 1 together is higher than the second frequency Frq2 with which the driver has performed the recommended action in the driving scene in which the driver is present in the vehicle 1 alone to drive (step S71). When the first frequency Frq1 is determined to be higher than the second frequency Frq2 (step S71: Yes), the notification processing unit 67 may determine whether the third frequency Frq3 with which the driver has performed the recommended action in the driving scene in which the police vehicle is present near the vehicle 1 is higher than the first frequency Frq1 with which the driver has performed the recommended action in the driving scene in which the particular passenger is present in the vehicle 1 together (step S73).

When the third frequency Frq3 is determined to be higher than the first frequency Frq1 (step S73: Yes, Frq3>Frq1 and Frq3>Frq2), the notification processing unit 67 may set the “police” to the “decider” of the three influence factors related to the action request expression and may thus adjust the expression in the information presentation (step S75). One reason why the “police” is set to the “decider” and the expression in the information presentation is thus adjusted may be because the “police”, which is the surrounding traffic participant, has a high degree of influence on the driving behavior of the driver. For example, when the expression strength set in step S21 is the “request”, the notification processing unit 67 may configure a setting to perform notification through the voice telling “please decelerate” and to display the police officer icon. When the expression strength is the “advice”, the notification processing unit 67 may configure a setting to perform notification through the voice telling “you may be arrested if you don't decelerate” and to display the police officer icon.

In contrast, when the third frequency Frq3 is not determined to be higher than the first frequency Frq1 (step S73: No, Frq1>Frq2 and Frq1≥Frq3), the notification processing unit 67 may set the “passenger” to the “beneficiary” of the three influence factors related to the action request expression and may thus adjust the expression in the information presentation (step S77). One reason why the “passenger” is set to the “beneficiary” and the expression in the information presentation is thus adjusted may be because the “passenger” has a high degree of influence on the driving behavior of the driver. For example, when the expression strength set in step S21 is the “request”, the notification processing unit 67 may configure a setting in which the expression is “Can you decelerate?”, resembling the way the family member talks. For example, when the expression strength is the “advice”, the notification processing unit 67 may configure a setting in which the expression is “If you can slow down, I may feel safer”, and the notification is performed through the voice.

When the first frequency Frq1 is not determined to be higher than the second frequency Frq2 in step S71 described above (step S71: No), the notification processing unit 67 may determine whether the third frequency Frq3 with which the driver has performed the recommended action in the driving scene in which the police vehicle is present near the vehicle 1 is higher than the second frequency Frq2 with which the driver has performed the recommended action in the driving scene in which the driver is in the vehicle 1 alone to drive (step S79).

When the third frequency Frq3 is determined to be higher than the second frequency Frq2 (step S79: Yes, Frq1≤Frq2 and Frq3≤Frq2), the notification processing unit 67 may set the “community or third party” to the “beneficiary” of the three influence factors related to the action request expression and may thus adjust the expression in the information presentation (step S81). One reason why the “community or third party”, which is the subject of obeying the rule as a social demand, is set to the “beneficiary” and the expression in the information presentation is thus adjusted may be because the “community or third party” has a high degree of influence on the driving behavior of the driver. For example, when the expression strength set in step S21 is the “request”, the notification processing unit 67 may configure a setting to perform notification through the voice telling “please decelerate” and to display the image of the injured child. When the expression strength is the “advice”, the notification processing unit 67 may configure a setting to perform notification through the voice telling “if you decelerate, you can avoid hurting people” and to display the illustration of the injured child.

In contrast, when the third frequency Frq3 is not determined to be higher than the second frequency Frq2 (step S79: No, Frq1≤Frq2 and Frq3≤Frq2), the notification processing unit 67 may maintain the current setting of the expression in the information presentation without changing the setting (step S83), and may end the process.

When the vehicle 1 is not traveling through the predetermined driving scene (step S17: No) or after the setting of the expression strength of the information presentation and the setting of the expression (steps S21 and S23) are configured, the processing circuit 51 may determine whether the driving of the vehicle 1 has been ended (step S25). When the driving of the vehicle 1 is not determined as having been ended (step S25: No), the notification processing unit 67 may return the process to step S15, and may repeat the above-described processes in the respective steps. In contrast, when the driving of the vehicle 1 is determined as having been ended (step S25: Yes), the notification processing unit 67 may end the information presentation operation.

### 1-4. Example Effects

As described above, the information presentation apparatus 50 according to the first example embodiment includes the one or more processors, and the one or more memories communicably coupled to the one or more processors, and is configured to perform the information presentation, to the driver, regarding the event to pay attention to in the surrounding traffic situation in which the vehicle 1 is traveling, or regarding the recommended action corresponding to the event to pay attention to. The information presentation apparatus 50 is configured to: acquire the information regarding the operation state of the vehicle 1 which the driver drives in the surrounding traffic situation or the behavior of the vehicle 1; and perform, based on the information regarding the operation state of the vehicle 1 or the behavior of the vehicle 1, the determination of the frequency with which the driver has performed the recommended action corresponding to the event to pay attention to in accordance with the information presentation. Further, the information presentation apparatus 50 is configured to change, based on the result of the determination of the frequency with which the driver has performed the recommended action, the expression in the information presentation to vary the impression which the driver is to receive from the information presentation. This helps to make it possible to select appropriate information presentation, based on a tendency of an impression that an individual driver receives from the information presentation. This helps to give an appropriate self-determining feeling to the driver and to thus cause the driver to actively perform safe driving.

In some embodiments, the information presentation apparatus 50 according to the first example embodiment may be configured to perform, based on the frequency with which the driver has performed the recommended action, the determination of the impression which the driver has received from the information presentation. Accordingly, it may be determined that the driver receives less of the forcing or instructing impression from the current information presentation when the frequency is higher, and it may be determined that the driver receives more of the forcing or instructing impression from the current information presentation when the frequency is lower. This helps to perform the information presentation that may give an appropriate self-determining feeling to the driver.

According to the first example embodiment, in some embodiments, the expression in the information presentation may be determined based on factors including the actor that is to perform the recommended action in the surrounding traffic situation, the beneficiary that is to benefit from performing of the recommended action in the surrounding traffic situation, and the decider that is to decide that the recommended action in the surrounding traffic situation is to be performed. The information presentation apparatus 50 may be configured to estimate the degree of the influence which each of the passenger of the vehicle 1, the surrounding traffic participant of the vehicle 1, and the social rule has on the driving behavior of the driver, based on the first information regarding the passenger of the vehicle 1, the second information regarding the surrounding traffic participant of the vehicle 1, and the third information regarding the operation state of the vehicle 1 or the behavior of the vehicle 1. The information presentation apparatus 50 may be configured to set one or more of the driver, the vehicle 1, the passenger, the surrounding traffic participant, and the social rule to each of the actor, the beneficiary, and the decider, and to change the expression in the information presentation to vary the impression which the driver is to receive, by changing what is set to each of the actor, the beneficiary, and the decider. This may incorporate the impression which the individual driver is to receive from the information presentation, and thus helps to give an appropriate self-determining feeling to the driver in a way adapted to the individual driver and to cause the individual driver to actively perform safe driving.

According to the first example embodiment, in some embodiments, the information presentation apparatus 50 may be configured to set one or both of the driver and the vehicle to the actor, and to change the expression in the information presentation to vary the impression which the driver is to receive, by setting one or more of the passenger, the surrounding traffic participant, and the social rule to the beneficiary or the decider, based on the estimated degree of the influence. This helps to set the expression in the information presentation based on the factor that can influence the individual driver, and to thus cause the individual driver to actively perform safe driving.

### 2. Second Example Embodiment

Next, a description is given of an information presentation apparatus according to a second example embodiment of the disclosure.

The information presentation apparatus according to the second example embodiment may be configured to vary the degree of the forcing or instructing impression which the driver is to receive from the information presentation, by changing contents of the information presentation accompanying an image display, and thus increase the self-determining feeling to be given to the driver. For example, the expression in the information presentation may include information expressing probability that preforming the recommended action in the surrounding traffic situation is to be suitable. The information presentation apparatus may be configured to: detect an object that possibly enters a traveling path of the vehicle and possibly intersects with the vehicle in the surrounding traffic situation; estimate a traveling path and a traveling direction which the object possibly intersecting with the vehicle possibly takes at a timing when the object is to intersect with the vehicle; and change the expression in the information presentation to vary the impression which the driver is to receive, by changing the information expressing the probability that the performing of the recommended action is to be suitable.

In some embodiments, the “probability that the performing of the recommended action in the surrounding traffic situation is to be suitable” may be presented as a display expressing a risk that can be caused when the driver does not perform the recommended action. In some embodiments, the image display presented in the second example embodiment may be accompanied by a voice or a sound.

The information presentation apparatus according to the second example embodiment may have a basic configuration similar to that of the information presentation apparatus 50 illustrated in FIG. 2.

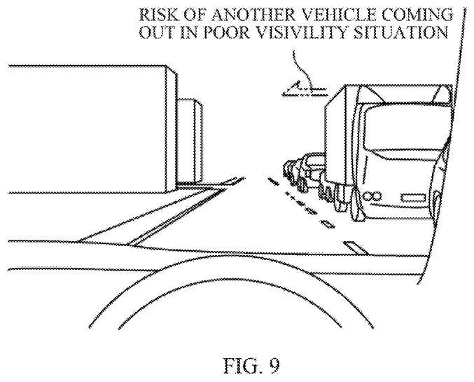

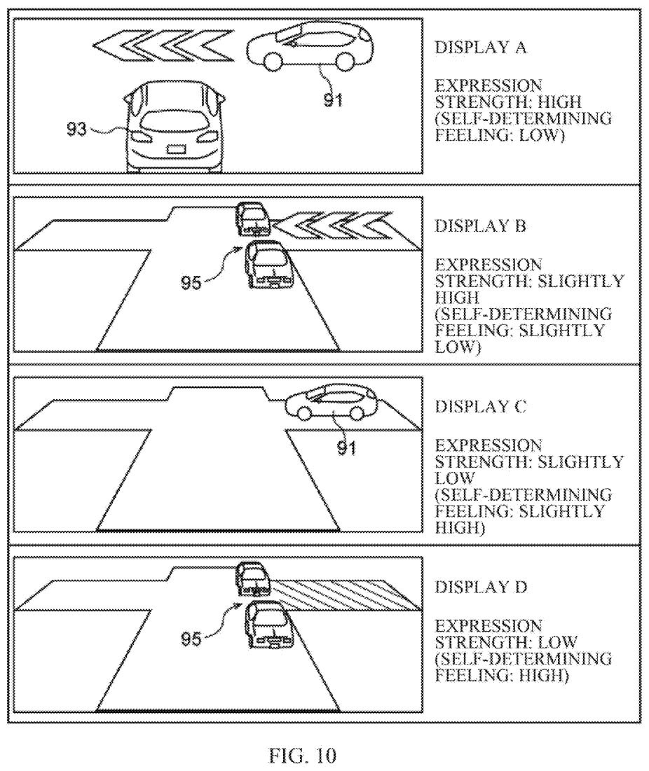

FIGS. 9 and 10 are each a diagram for describing an example of the information presentation to be performed by the information presentation apparatus 50 according to the second example embodiment.

FIG. 9 illustrates a driving scene having a risk of another vehicle coming out from a line of vehicles into a region in front of a traveling own vehicle, in a condition where an intersection with no traffic light has poor visibility due to the line of vehicles in traffic congestion on an oncoming lane. Hereinafter, the above-described other vehicle may be referred to as an “intersecting vehicle”.

For example, one of the recommended actions to be performed in the driving scene illustrated in FIG. 9 may be decelerating in advance at a point before the intersection so that it is possible to deal with the situation even if the intersecting vehicle suddenly comes out from the line of vehicles. Favorability to perform such a recommended action may vary depending on, for example, the presence or absence of the intersecting vehicle and a traveling state of the intersecting vehicle. Such favorability may influence the self-determining feeling.

FIG. 10 illustrates a relationship between contents of an image display suggesting the presence of an intersecting vehicle 91 and the degree of the forcing or instructing impression which the driver is to receive, i.e., the expression strength.

For example, display A may express the intersecting vehicle 91 and an own vehicle 93 themselves with images, and may also express a traveling state of the intersecting vehicle 91. The driver who sees such display A may think that the own vehicle 93 will definitely intersect with the intersecting vehicle 91 and may be brought into a situation of being forced to decelerate. Therefore, the display A may be an expression having a high expression strength, and may decrease the self-determining feeling of the driver.

For example, display B may express the intersecting vehicle 91 and its traveling direction together. The driver who sees such display B may understand that some kind of mobile body can travel across the region in front of the vehicle and may more easily select an operation of decelerating. Therefore, the display B may be an expression having a slightly high expression strength, and may slightly decrease the self-determining feeling of the driver.

For example, display C may simply express the presence of the intersecting vehicle 91, and may not include an expression regarding the traveling direction of the intersecting vehicle 91. Such display C may be unclear in indicating that some kind of mobile body is to travel across the region in front of the vehicle and may let the driver decide whether he, she, or they selects the operation of decelerating. Therefore, the display C may be an expression having a slightly low expression strength, and may slightly increase the self-determining feeling of the driver.

For example, display D may express a region which the driver cannot see due to a line of vehicles 95, and may not include a display of the intersecting vehicle 91. Such display D may be unclear in indicating the presence of an intersecting object, and may completely let the driver decide whether he, she, or they selects the operation of decelerating. Therefore, the display D may be an expression having a low expression strength, and may increase the self-determining feeling of the driver.

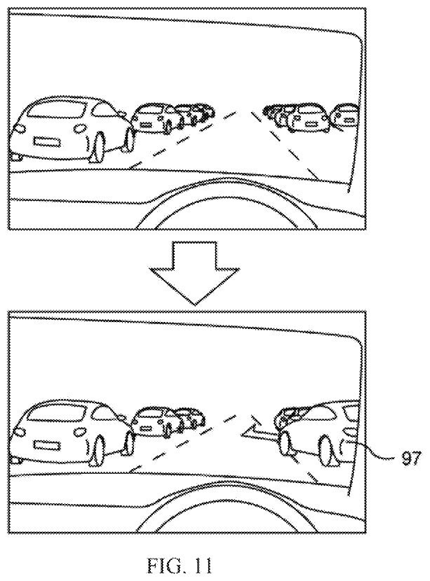

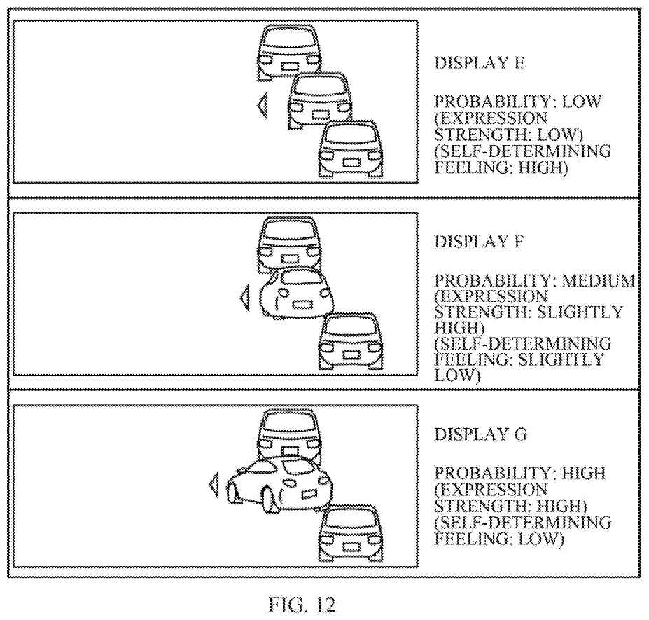

FIGS. 11 and 12 are each a diagram for describing another example of the information presentation to be performed by the information presentation apparatus 50 according to the second example embodiment.

In the example illustrated in each of FIGS. 11 and 12, the information presentation apparatus 50 may express the probability that the performing of the recommended action is to be suitable, based on, out of a traveling path and a traveling direction which an object of interest in the estimation can take at a timing when the object is to intersect with the vehicle, information regarding the object corresponding to a traveling path and a traveling direction that has a greater distance from a reference. The reference may be the current position and the current traveling direction of the object.

FIG. 11 illustrates a driving scene in which another vehicle 97 suddenly performs lane change from an adjacent lane while the own vehicle is traveling among a line of vehicles in traffic congestion. In the driving scene illustrated in FIG. 11, the information presentation apparatus 50 may express the probability that the performing of the recommended action is to be suitable, with an estimated position and an estimated traveling direction of the object that can enter the traveling path of the own vehicle and intersect with the own vehicle. For example, as illustrated in FIG. 12, the information presentation apparatus 50 may associate higher probability that the recommended action is to be suitable with an expression more clearly expressing a state of the other vehicle 97 entering the traveling path of the own vehicle.

Information presentation such as that illustrated in FIG. 12 is not limited to the illustrated three-level example, and may express the degree of the other vehicle 97 entering the traveling path of the own vehicle in a continuous manner. This helps to give an appropriate self-determining feeling to the individual driver and to thus cause the driver to actively perform safe driving.

A processing operation to be performed by the information presentation apparatus 50 according to the second example embodiment may correspond to the processing operation illustrated in the flowchart of FIG. 5 without step S23. The information presentation apparatus 50 according to the second example embodiment may adjust the expression strength in accordance with the flowchart illustrated in FIG. 6 in determining the expression strength in step S21. This helps to give an appropriate self-determining feeling to the individual driver and to thus cause the driver to actively perform safe driving.

However, in the image display example illustrated in FIG. 10 or 12, the processing operation illustrated in the flowchart FIG. 5 including step S23 may be performed when the notification is performed through the voice.

Although some example embodiments of the disclosure have been described in the foregoing by way of example with reference to the accompanying drawings, the disclosure is by no means limited to the embodiments described above. It is apparent that a person having ordinary knowledge in the field of the technique to which the disclosure pertains can conceive of various modifications or alterations within the scope of the technical concept described in the claims, and the modifications and alterations are naturally understood to be within the technical scope of the disclosure.

For example, in the example embodiments described above, the information presentation apparatus may include the electronic control unit mounted in the vehicle; however, the technique according to one embodiment of the disclosure is not limited to the example described above. In some embodiments, for example, the information presentation apparatus may be configured to acquire measurement information obtained by the surrounding environment sensor of the vehicle and may include a mobile terminal or an external server configured to send a drive command signal to the notification device.

Further, the technique according to one embodiment of the disclosure may be implemented by any of a vehicle in which the information presentation apparatus described in the example embodiments above is mounted, a driving assisting method to be performed by the information presentation apparatus, a computer program that causes a computer to operate as the above-described information presentation apparatus, and a non-transitory tangible recording medium containing the computer program.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

The processing circuit 51 illustrated in FIG. 2 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the processing circuit 51. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the processing circuit 51 illustrated in FIG. 2.

1. An information presentation apparatus configured to perform information presentation, to a driver who drives a vehicle, regarding an event to pay attention to in a surrounding traffic situation in which the vehicle is traveling, or regarding a recommended action corresponding to the event to pay attention to, the information presentation apparatus comprising:
one or more processors; and
one or more memories communicably coupled to the one or more processors,
the one or more processors being configured to
acquire information regarding an operation state of the vehicle which the driver drives in the surrounding traffic situation or behavior of the vehicle,
perform, based on the information regarding the operation state of the vehicle or the behavior of the vehicle, a determination of frequency with which the driver has performed the recommended action corresponding to the event to pay attention to in accordance with the information presentation, and
change, based on a result of the determination of the frequency with which the driver has performed the recommended action, an expression in the information presentation to vary an impression which the driver is to receive from the information presentation.

2. The information presentation apparatus according to claim 1, wherein the one or more processors are configured to perform, based on the frequency with which the driver has performed the recommended action, a determination of the impression which the driver has received from the information presentation.

3. The information presentation apparatus according to claim 1, wherein
the expression in the information presentation is determined based on factors comprising
an actor that is to perform the recommended action in the surrounding traffic situation,
a beneficiary that is to benefit from performing of the recommended action in the surrounding traffic situation, and
a decider that is to decide that the recommended action in the surrounding traffic situation is to be performed, and
the one or more processors are configured to
estimate a degree of an influence which each of a passenger of the vehicle, a surrounding traffic participant present in the surrounding traffic situation of the vehicle, and a social rule has on driving behavior of the driver, based on first information regarding the passenger, second information regarding the surrounding traffic participant, and third information regarding the operation state of the vehicle or the behavior of the vehicle, and
set one or more of the driver, the vehicle, the passenger, the surrounding traffic participant, and the social rule to each of the actor, the beneficiary, and the decider, and change the expression in the information presentation by changing what is set to each of the actor, the beneficiary, and the decider.

4. The information presentation apparatus according to claim 3, wherein
the one or more processors are configured to
set one or both of the driver and the vehicle to the actor, and
change the expression in the information presentation by setting one or more of the passenger, the surrounding traffic participant, and the social rule to the beneficiary or the decider, based on the estimated degree of the influence.

5. The information presentation apparatus according to claim 1, wherein
the expression in the information presentation comprises information expressing probability that performing of the recommended action in the surrounding traffic situation is to be suitable, and
the one or more processors are configured to
detect an object that possibly enters a traveling path of the vehicle and possibly intersects with the vehicle in the surrounding traffic situation,
estimate a traveling path and a traveling direction which the object possibly intersecting with the vehicle possibly takes at a timing when the object is to intersect with the vehicle, and
change the expression in the information presentation by changing the information expressing the probability that the performing of the recommended action is to be suitable.
